(19) United States
(12) Patent Application Publication
(10) Pub. No.: US 2023/0168083 A1
(43) Pub. Date: Jun. 1, 2023

(54) SYSTEM FOR GENERATING A SIGNAL REPRESENTATIVE OF THE PROFILE OF A SURFACE MOVING RELATIVE TO THE SYSTEM

(71) Applicants: COMPAGNIE GENERALE DES ETABLISSEMENTS MICHELIN, Clermont-Ferrand (FR); Centre National De La Recherche Scientifique, Paris (FR); Universite Paul Sabatier, Toulouse III, Toulouse (FR); Institut National Polytechnique De Toulouse, Toulouse (FR)

(72) Inventors: BASTIEN GRIMALDI, CONCA (FR); REMI COTE, Clermont-Ferrand (FR); FLORIAN BREMOND, Clermont-Ferrand (FR); THIERRY BOSCH, Toulouse (FR); FRANCIS BONY, Lavalette (FR)

(21) Appl. No.: 17/921,708

(22) PCT Filed: Apr. 27, 2021
(86) PCT No.: PCT/EP2021/060966

§ 371 Date: Oct. 27, 2022

(30) Foreign Application Priority Data
Apr. 27, 2020 (FR) FR2004162

(51) Int. Cl. G01B 11/30; G01B 11/24; G01B 9/02015; G01B 9/02; G01B 9/02055

(52) U.S. Cl. CPC G01B 11/303; G01B 11/2441; G01B 9/02022; G01B 9/02045; G01B 9/02082

(57) ABSTRACT

A system (1) for generating a signal from a surface (22) having a speed V in a direction U, comprising: a light source (2) emitting a Gaussian light beam along a first optical path (11); a sensor (3) able to evaluate the effects of the electromagnetic interference of the first beam; a means (2′, 4) for generating a second Gaussian light beam along a second optical path (12); a second sensor (3′) able to evaluate the effects of electromagnetic interference of the second beam; a focusing lens (5, 6) located on the first and/or the second optical path (11, 12), focusing the light beam at a distance f and defining an upstream optical path (11′, 12′); and a means (4′, 7) for routing the second beam able to redirect the second path (12′) in the direction of the first path (11′).

### FIELD OF THE INVENTION

The present invention relates to a system for generating a signal representative of the profile of a surface moving relative to the system.

### TECHNOLOGICAL BACKGROUND

Knowing the profile of a surface of an object is useful for multiple types of application. First of all, when the object is moving relative to a second object, it is necessary to know this profile to ensure the relative mobility between the two objects.

Indeed, it is possible to deduce, from the profile of the surface, the roughness thereof, making it possible to adapt for example the relative speed between the two surfaces so as to ensure a condition of adhesion. Second of all, when inspecting the quality of an object, the profilometry of the surface is a parameter subjected to surveillance since it is a sign of evolution of the manufacturing process, for example. Owing to manufacturing defects but also to ageing or wear in service of the surface of an object or to varying external conditions, it is useful to be able to have regular access to profile information. For example, in the field of land transport, knowing the profile of the ground at a millimetre scale is important for adapting active safety systems of the vehicle to the conditions of ground adhesion, which is dependent on the surface roughness of the ground. Similarly, in the field of object manufacturing, it is useful to measure the profile of the outer surface of manufactured objects to ensure compliance with specifications and to adapt the manufacturing process according to this parameter.

Thus, real-time knowledge of the profile of any surface of an object is important. However, there is a desire for profile-measuring devices that are physically non-intrusive with respect to the object to be evaluated or with respect to the device on which it is likely to be mounted. In addition, it should have little impact on the current operation of the devices so as not to affect the efficiency of these devices. Finally, it should be potentially economical both in terms of purchase price and in terms of use, and consume little energy.

Among devices for measuring the roughness of the ground, the rugolaser makes it possible to measure profiles dynamically. The measuring principle is based on the use of a pulsed laser source emitting vertically in the direction of the outer surface to be measured. The laser source is coupled to focusing optics and a CCD optical potentiometer or photoreceptor array. Depending on the laser/target distance, the optics focus the image of the point of impact of the laser beam at a given position on the sensor. By locating this position on the potentiometer, it is possible to arrive at the height of the profile of the target.

The drawback of such a device lies in the bulk embedded on the mobile device, its purchase cost and its low measurement flexibility in comparison with the use of the mobile device, since the system settings and the analysis of the measurements require time and post-processing is generally performed after the measurement. It is therefore not possible to obtain the information in real time.

Among devices for measuring surface roughness in terms of quality control for a manufactured object, mention may be made of imaging and lighting devices. However, this type of equipment is not suitable for live quality control since the processing time consumes flow time and the object is generally static or quasi-static. Although it makes it possible to access a three-dimensional observation of the outer surface of the object, this processing being well suited to a quality logic based on random sorting of objects, this is not the case for live quality control of all objects.

The present invention relates to a device for generating signals that are able to be used in real time and representative of the profile of a surface on a two-dimensional plane, simultaneously solving the problems encountered by devices from the prior art in terms of response time, embedded on devices while at the same time being non-intrusive and not having any impact on the operation of the object itself. Finally, some variants of the invention are also energy-efficient and inexpensive.

### DESCRIPTION OF THE INVENTION

The invention relates to a system for generating at least one signal representative of the profile of an outer surface of a medium having a median plane and having a relative speed V with respect to the system in a direction U, in use thereof with an outer surface of a medium having a median plane, comprising:
A first light source able to emit a first Gaussian beam of coherent and monochromatic light, the wavelength λ₁ of which is adapted to the optical absorption characteristics of the medium, along a first optical path;
At least one first sensor able to evaluate the effects of electromagnetic interference between a portion of the first emitted light beam and a portion of the light beam backscattered from the outer surface of the medium and delivering an electrical signal;
An optical system comprising:
   at least one first focusing lens for focusing all or part of the first light beam at a focusing distance f1 and defining a first optical path;
   a first optical device located upstream or downstream of the at least one first focusing lens, able to redirect all or part of the first light beam towards the outer surface at a first angle of incidence θ1 along a readout line on the outer surface in the direction U;
   at least one second optical device comprising
      a means for generating at least one second Gaussian beam of coherent and monochromatic light of wavelength λ2 adapted to the optical absorption characteristics of the medium along a second optical path; the second light beam being focused at a focusing distance f2 along a second optical path towards the outer surface;
      a means for routing the at least one second light beam, arranged such that the second optical path points incidentally towards the outer surface at a second angle of incidence θ2 and able to follow the readout line on the outer surface, and
optionally, an electronic device at the output of the electrical signal from the at least one sensor, comprising an electronic amplifier circuit;
characterized in that the wavelengths of the first and second light beams have the same sensitivity to the optical reflectivity characteristics of the outer surface of the medium, in that the combination of the focusing distance and the optical path for each light beam defines two geometric points d1 and d2 corresponding to the focal points of each light beam located on either side of the median plane of said outer surface, in that the distance between the geometric points d1 and d2 is greater than the greatest Rayleigh length of the first and second Gaussian light beams and in that the projections of the angles of incidence θ1 and θ2 in a plane defined by the normal to the median plane and the direction U are greater than 1 degree, preferably greater than 5 degrees, with respect to the normal to the median plane of the outer surface of the medium.

The invention relates to a system for generating at least one signal representative of the profile of an outer surface of a medium having a median plane and having a relative speed V with respect to the system in a direction U, comprising:
A first light source able to emit a first Gaussian beam of coherent and monochromatic light, the wavelength λ1 of which is adapted to the optical absorption characteristics of the medium, along a first optical path;
A first sensor able to evaluate the effects of electromagnetic interference between a portion of the first emitted light beam and a portion of the beam backscattered from the outer surface of the medium of the first light beam, and delivering a first electrical signal;
A means for generating at least one second Gaussian beam of coherent and monochromatic light of wavelength λ2 adapted to the optical absorption characteristics of the medium along a second optical path;
A second sensor located on the second optical path able to evaluate the effects of electromagnetic interference between a portion of the second emitted light beam and a portion of the beam backscattered from the outer surface of the medium of the second light beam, and delivering a second electrical signal;
At least one first focusing lens located on the first and/or the second optical path for focusing all or part of the light beam at a focusing distance f and defining an upstream optical path, and
A means for routing the at least one second light beam able to redirect at least a portion of the second optical path in the same direction as a portion of the first optical path,
   characterized in that the two optical paths are coplanar, in that the wavelengths of the first and second light beams have the same sensitivity to the optical reflectivity characteristics of the outer surface of the medium, in that the combination of the focusing distance and the optical path for each light beam defines two distinct geometric points d1 and d2 corresponding to the focal points of each light beam, in that the distance between the geometric points d1 and d2 is greater than the greatest Rayleigh length of the first and second Gaussian light beams and in that the direction vectors of the first and second optical path define an angle θ less than 3 degrees, preferably less than 1 degree, very preferably the angle is zero.

Imposing that the optical paths are coplanar ensures that, during use thereof, the device will impose that the optical paths follow the same readout line on the outer surface. Imposing that the direction vectors of the optical paths define a small angle θ ensures that the geometric targets on the readout line of the outer surface will be identical.

This device makes it possible to generate a first electrical signal at the output of the sensor that translates the effects of electromagnetic interference generated between the first incident light beam from the first source and the light beam backscattered by the outer surface resulting from the first incident beam. Here, the information relating to a variation in the emitting power of the first light source is sufficient. The term “backscattered beam” is understood here to mean that this corresponds to the incident beam that is reflected and/or scattered by the outer surface and that follows the same optical path as the incident beam in the opposite direction. These effects are also modulated by the distance between the geometric point d1 where a first portion of the Gaussian light beam is focused and the outer surface of the medium due to the Gaussian propagation of the light beam. The two beams interfere due to the spatial and temporal coherence between the incident beam and the backscattered beam. The observed variations represent a succession of phenomena driven by the harmonic frequencies related to the Doppler effect. The fundamental frequency of the Doppler effect depends simultaneously on the relative speed V between the system and the outer surface, on the angle of incidence θ of the beam on the outer surface with respect to the normal to the outer surface along the direction U and on the wavelength λ of the light beam. It is thus necessary for the incident wave to generate an angle of at least 1 degree with respect to the normal to the outer surface along the direction U in order for the Doppler effect to be able to be observed in the signal. In practice, an angle of 5 degrees makes it possible to ensure observation of the Doppler effect beyond the geometric imperfections of any imperfect optical system and to obtain an easily usable signal. Taking a monochromatic light wave avoids interference between different wavelengths of a polychromatic light, making the harmonics of the monochromatic wavelength easily visible in the signal from the sensor. The same operation is performed with a second beam of monochromatic light the geometric position d2 of which with respect to the outer surface along the readout line described by the first optical path is different from the first geometric position d1. The two geometric positions d1 and d2 necessarily surround the median plane of the outer surface of the medium under observation in order to easily identify the distance from the outer surface. Two items of information proportional to the distance between a given geometric point d1 or d2 and the outer surface are thus retrieved. Of course, it is preferable for the distance between these two geometric points d1 and d2 to be greater than the greatest Rayleigh length of the Gaussian beam in order to obtain a high-quality signal with a spatial resolution adapted to what is sought in terms of discretization of the outer surface. Indeed, at the Rayleigh length, the shape of a light beam is modified by increasing the radius of the beam by a factor of root 2. This modification of the beam will have a direct impact on electromagnetic interference between the emitted and backscattered beams and will therefore quantify the distance to the focal position of each of the first and second light beams. If the two focal lengths differ by a distance less than the greatest Rayleigh length, the light beams do not diverge enough for the information about the distance between the focal point and the outer surface to be perceived in the output signal from the sensor.

The distance information provided by the second light beam is coded on a second electrical signal, in which case the harmonics due to the Doppler effect may be the same. Importantly, the impact of the reflectivity of the outer surface should be similar between the two light beams, which means either that they have the same wavelength or that their wavelength, although different, is insensitive to the optical reflectivity characteristics of the outer surface of the medium under observation.

By having information relating to two distances of the outer surface from two references d1 and d2 along the same readout line, it is possible to arrive, through signal processing, at a two-dimensional profile of the outer surface along the readout line regardless of the relative speed V of the system with respect to the medium. The spatial discretization of the profile is proportional to the sampling frequency of the signal and to the relative speed V. By adapting the sampling frequency as a function of the speed V, it is possible to obtain the desired spatial precision of the discretization of the readout line. The measurement is thus not impacted by the usage conditions between the medium under observation and the device receiving the system, and allows measurement at high relative speed V in the direction U.

The system preferably also comprises an electronic-type electrical signal amplifier when the amplitudes of the signals delivered by the sensors are low, in particular due to the width of the frequency band of the signal, it is necessary to amplify these signals without losing information.

Finally, the system does not require any complex adjustment since no precise orientation constraint on the light beams with respect to the outer surface is required; only alignment in the direction U of the two incident beams is necessary, which is satisfied when the optical paths of the first and second light beams are coplanar. The coplanarity of the optical paths ensures that the two optical paths follow the same readout line on any outer surface.

The light source may be for example a laser source, such as a laser diode for example. These laser-type sources generate coherent light, and the propagation of light is also naturally Gaussian. The sensor has to measure electromagnetic interference between the incident light and the light backscattered by the outer surface. This involves identifying a spatial area where the two beams are aligned, or at least a portion of them. The simplest technique is to place the sensor on the optical path between the light source and the surface. However, it is entirely possible to deflect a portion of one or both of these beams to make them coincide outside the optical path. The sensor may be for example a photodiode, a phototransistor or a current or voltage sensor for the power supply of the light source.

The first optical device and/or the means for routing the second light beam includes for example means for orienting at least part of the system with respect to the outer surface during the use thereof so as to at least partially orient the angles of incidence of the first and/or second light beam with respect to the outer surface.

The term “Gaussian beam” is understood to mean that the propagation of light in the direction of propagation of the beam is Gaussian.

The term “optical path” is understood to mean the succession of contiguous spatial positions followed by the light beam between a light source or a means for generating a light beam and the outer surface of the medium under observation.

The term “optical path” is understood to mean at least a portion of an optical path between the last focusing lens focusing the light beam before the outer surface and the farthest point between the outer surface and the focal point of the light beam.

According to a first specific embodiment of the system, the at least one first focusing lens possibly being located downstream of the first optical device on the first optical path, the first optical device and the means for generating at least one second beam are pooled and comprises an optical splitter element located on the first optical path of the first light beam, the at least one second light beam is the other portion of the first light beam, the means for generating at least one second laser beam comprises in this case at least one second focusing lens with a focal distance f2 located downstream of the first optical device. And the second optical device comprises, downstream of the optical splitter element and in order along the second incident optical path, optionally an optical element able to absorb the light on the return path, and a sensor able to evaluate the electromagnetic interference between a part of the second incident light beam and a part of the beam backscattered on the outer surface of the medium by the second incident light beam. Obviously, if the first focusing lens is situated upstream of the first optical device over the first optical path, it is not necessarily essential to introduce a second focusing lens, the differentiation of the geometric points d1 and d2 being able to be performed by differentiating the lengths of the first and second optical paths.

This is a case in which a second sensor is placed after the generation of the second non-focused light beam. Furthermore, the routing means preferentially comprises an optical element absorbing the light in the return direction only in order for the interference generated by the backscattering of the second light beam not to generate disturbance on the output signal of the first sensor. Thus, the signal representative of the outer surface is coded on two electrical signals each originating from a sensor associated with each optical path. Having previously split the first light beam using the optical splitter device, the interference observed by each sensor is representative of the light interaction of the outer surface with a single optical path. Consequently, no specific condition is demanded on the angular dependence between the angles of incidence of the first and second optical paths which makes it possible to have an angle formed by the two optical paths which is low, even zero.

Preferably, in the case of using the system with a medium to be studied having an outer surface having a median plane, the first and second optical paths do not intersect before having reached the outer surface of the medium.

If a single light source is used, the first and second light beams are mutually coherent. As a result, these first and second light beams are likely to interfere electromagnetically with one another, be this on the incident or backscattered paths. This interference may alter the quality of the signal measured by the sensor and therefore lead to an error in the quality of the signals from the sensor. Ensuring the above condition minimizes the risk of creating parasitic electromagnetic interference between the first and second light beams, thereby improving the quality of the output signals from the sensor and consequently the measurement of the profile of the outer surface of the medium. Finally, the improvement of the measured signal by this condition is potentially ensured on both optical paths.

According to a second embodiment of the system, the means for generating the at least one second light beam comprises
a second light source able to emit a second light beam along a second optical path; and
the means for generating the at least one second light beam comprises a second lens focusing at the focusing distance f2 and/or the means for routing the at least one second light beam comprises at least one mirror such that the length of the second optical path is different from the length of the first optical path.

Here, it is the case where the system comprises a first and a second monochromatic light sources which is dealt with. Obviously, these two monochromatic sources can be generated by a single source of coherent polychromatic light in which the wavelengths are dissociated. In this particular case, it would be appropriate to separate the different wavelengths of the light beam using at least one suitable chromatic filter. However, in the general case, two distinct monochromatic light sources are used. Here, the distance information of the first and second light beams will necessarily be coded on two distinct electrical signals. These signals are the outputs of the first and second sensors of the system that should be amplified using the electronic device of the system.

Next, the first and second light beams must be focused using at least the first focusing lens and, if necessary, the second focusing lens. In this second case, by choosing different focal distances f1 and f2, that makes it possible to obtain two different geometric points d1 and d2 up to the outer surface on the readout line even if the geometric position of each lens with respect to the outer surface is identical. If the single focusing lens or the position with respect to the outer surface is used and the focusing distances of the two lenses are identical, the second optical path should be increased through the routing means comprising at least one mirror to modify the second optical path. Thus, two distinct geometric points d1 and d2 are indeed generated on either side of the median plane of the outer surface.

According to a preferential second embodiment of the system, the wavelengths of the first and second light beams being different, the system comprises an optical element merging the first and second light beams such that the two optical paths are partly aligned and point simultaneously to the same geometric point of the outer surface.

The use of two chromatic sources in which the wavelengths are different or the sources are physically different makes it possible to observe the condition. Then, each source having its associated sensor, the information is then coded on the two electrical signals. The advantage of this device is that the two light beams are aligned after their passage through the merging optical element and point physically to the same point on the readout line. Thus, no temporal realignment of the signals needs to be done. The information from the electrical signals can therefore be more rapidly used which renders the system more effective in terms of computation time and accuracy by limiting the errors inherent in the phasing of the signals. Furthermore, the two angles of incidence are also similar, which, here, reduces the reflectivity deviations of the outer surface.

Preferably, in the case of using the system with a medium to be studied having an outer surface having a median plane, the coherence length of the first laser beam and/or of the second laser beam is at least greater than twice the greatest length of the first and second incident optical paths to the outer surface of the medium.

The payload information is obtained by observing electromagnetic interference between the incident light beam and the beam backscattered from the outer surface of the medium of the incident light beam. The sensor should necessarily be located in a geographical area where the incident and backscattered beams are mutually coherent so as to interfere. Although the sensor may be remote from the incident optical path, it is often more convenient to position the sensor on the incident optical path. Since the backscattered beam has to pass through the incident optical path at least once in order to be generated, the mentioned length condition ensures the ability to position the sensor anywhere on the longest optical path.

Preferably, in the case of using the system with a medium to be studied having an outer surface having a median plane, the angles of incidence θ1 of the first beam and θ2 of the second light beam are contained within a cone the axis of revolution of which is the normal to the median plane of the outer surface and the aperture angle of the cone is less than or equal to 45 degrees, preferably less than or equal to 30 degrees.

Regardless of the embodiment, it is desired to observe the profile of the outer surface of a medium. Ideally, the angle of incidence is along the normal to the median plane, thereby making it possible to observe any convex surface profile. In fact, the system imposes at least a certain inclination in the plane of relative movement of the system with respect to the outer surface so as to observe Doppler effects. This low inclination has little impact on the observation of a convex surface. However, if the inclination is greater and regardless of the orientation of the light beam, some areas of the convex outer surface cannot be observed, and these will be areas masked by areas located above the masked area of the outer surface. Imposing a maximum inclination of 45° minimizes these masked areas of the readout surface. Preferably, the aperture angle of the cone should be less than 30 degrees, thereby making it possible to halve the masked surface while still allowing differentiated angles of inclination that are acceptable even in the case of a single first sensor.

Very preferably, the sensors are contained within the group comprising a phototransistor, a photodiode, an ammeter and a voltmeter.

Multiple sensor technologies may be used to globally evaluate the temporal variations in the electromagnetic interference between the monochromatic coherent waves of the incident beam and the backscattered beam, such as for example those that evaluate light power. If the power supply for the light source is not fixed and the interference is generated as far as the light source, variations in the consumption of the source, for example a laser, may appear on the power supply signal. A high-resolution ammeter or voltmeter thus makes it possible to observe small electrical variations at the point of electric power supply to the light source. This will work well for specific electrical devices and when the monochromatic sources are distinct.

More conventionally, the system may be equipped as a sensor of a photodiode or a phototransistor. These types of light sensor will be capable of observing the temporal variations in monochromatic coherent light that are generated by interference, independently of the power supply circuit for the light source.

Moreover, these are standard elements of the packaging of laser diodes, thereby making these devices inexpensive and easy to implement. Finally, since it is desirable for a wave backscattered at the same wavelength to align with the wave of the incident beam, conventional laser diodes, due to their dedicated optical cavity for amplifying light, perform this function if the optical interface allows transmission of the reflected wave. This is the case with standard laser diodes, which also have a low cost price.

Indeed, in sophisticated laser diodes, it is sought more to minimize or even prevent the reflected waves from penetrating into the optical cavity of the diode, requiring optical surface treatments at the external optical interfaces.

Advantageously, the wavelength of the first and of the second light beams is between 200 and 2000 nanometres, preferably between 400 and 1600 nanometres.

The device according to the invention, in the case of using the system with a medium to be studied having an outer surface having a median plane, consists in focusing the first and second light beams towards the outer surface of the medium to be observed. Due to the very nature of optical systems, what is known as an Airy spot of a certain dimension is generally obtained at the focusing distance due to the physical phenomena of light diffraction. However, the dimension of this concentric spot is directly proportional to the wavelength of the light beam. Using wavelengths of visible light in general gives reasonable spot dimensions that allow a spatial resolution of the outer surface along the readout line that is suitable for the desired applications. Of course, the smaller the wavelength, the blue or the violet or the ultraviolet, the smaller the dimension of the Airy spot, thus increasing the resolution of the readout line, the thickness of which, along the direction perpendicular to the readout line, is also proportional to the wavelength. On the other hand, operating in the red or the infrareds generates metric precision that is lower but that may remain suitable depending on the application and depending on the desired resolution criteria.

Specifically, the first light source and/or the second light source is a laser diode.

As already mentioned, this is by nature a source of monochromatic, coherent light for which the propagation of the light beam is Gaussian when the laser diode operates at its threshold. In addition, the diode comprises an optical cavity, which may be the ideal location for observing electromagnetic interference between the incident beam and the backscattered beam if the external optical interface allows transmission of backscattered waves. At this time, with the optical cavity serving as an amplifying medium for the generation of light, any light power sensor will deliver a signal easily able to be used by the principle of self-mixing, which is another term for optical feedback. Finally, the packaging of a laser diode is compact and inexpensive. As a result, it is an economical solution that meets the need perfectly.

The invention also relates to a static or mobile device equipped with a system for generating at least one signal representative of the profile of an outer surface of a medium.

Indeed, the system covers only the essential aspects of the measurement. The system may therefore be installed on a device that allows the system to be integrated into the desired operating environment. This device may thus be mobile, such as for example a land vehicle moving relative to the ground. The ground is then the observation medium for the measurement system. The device may also be static, such as an industrial station for inspecting a linear appearance in relation to the scrolling of objects on a conveyor belt. The system installed on a mobile or static device may also observe the rotational movements of a medium relative to the device in order to analyse uniformity defects of the outer surface of this medium.

The invention also relates to a method for obtaining the profile of the outer surface of a medium, comprising the following steps:
Obtaining two time signals A and B coming from the system for generating at least one signal representative of the profile of an outer surface of a medium, associated with the geometric positions d1 and d2 for, at all times, the same geometric target on the readout line of the outer surface;
Determining at least one Doppler frequency associated with each time signal A and B;
Sampling each time signal A and B at a frequency greater than twice, preferably 10 times, the at least one Doppler frequency in order to obtain a payload signal;
Determining an envelope of the payload signal of each signal A and B;
Performing a relative combination between the envelopes of each signal A and B in order to obtain a monotonic and bijective function F; and
Determining the profile of the outer surface through a calibration of the function F.

Here, it is first necessary to have two time signals corresponding, at all times, to the response of the same geometric point of the readout line on the outer surface of the medium under observation. The distance information is carried by the fundamental and the harmonics of the Doppler frequency. Consequently, it is necessary to determine the Doppler frequency on each signal. This depends on the relative speed V of movement in the direction U between the system and the medium under observation. However, it also depends on the angle of incidence θ with respect to the normal to the median plane of the outer surface. Finally, the Doppler frequency is also a function of the wavelength λ of the light beam. Knowing all of these parameters, it is theoretically possible to determine the Doppler frequency, its fundamental. Another solution consists in frequency-analysing the time signal in order to determine the frequency and its harmonics, which should also emerge from the frequency analysis of the signal.

It is thus important that the sampling frequency of the time signals is at least greater than twice the Doppler frequency so that the payload signal carries information that is definitely reliable (signal processing—Shannon's theorem) on the fundamental of the Doppler frequency. However, depending on the application, the information may also be carried by the first harmonics of the Doppler effect; it is then preferable to perform enough sampling to have reliable information on the successive harmonics.

Next, to extract the distance information on the payload signal, it is first necessary to extract the envelope of the payload signal, which represents the extreme temporal variations of the recorded electromagnetic interference. This envelope may be constructed on the minimum value of the payload signal or on the maximum value of the payload signal. As a variant, it is also possible to take the maximum value of the absolute value of the envelope, which generally oscillates around the zero value. Here, it is the general information that carries the payload information, which justifies taking the envelope of the signal.

Finally, the last step is determining the profile along the readout line of the outer surface. For this purpose, a bijective function F is created, this being a relative mathematical combination of the envelopes of the signals resulting from the two optical paths. The advantage of the relative mathematical combination is that a calibration step may be performed a priori using a target representative of the nature of the media that it is desired to measure. The calibration then does not require the use of conditions similar to the desired measurement, but only requires ensuring the proportionality of the responses between the two signals. The result of this combination gives a quantity that, through a monotonic and bijective function F, translates one and only one distance E relative to a reference point through the step of calibrating the function F, despite this calibration not having not performed on the measurement medium. Real-time measurement of the profile of the outer surface of the medium is thus ensured. The variations in the distance E between the points of the readout line make it possible to automatically generate the profile of this same readout line, thereby allowing real-time processing of the profile, since this requires few computing resources.

According to one particular embodiment, the step of obtaining two time signals A and B for the same geometric target of the readout line comprises the following steps:
Obtaining two time signals A and B for, at all times, two geometric targets on the readout line of the outer surface;
Establishing the distance X on the median plane along the direction U between the two geometric targets of the readout line;
Determining the relative speed V in the direction U between the generation system and the outer surface;
Determining the time offset dT between the two light beams associated with the distance X and the speed V; and
Applying at least a portion of the time offset dT to the time signal A and/or to the time signal B.

The system for generating signals representative of the profile of the outer surface does not necessarily phase the first and second optical paths. In this case, this preparatory step for the signals is essential for obtaining two time signals from the same point of the readout line of the outer surface in a robust and reliable manner.

Advantageously, the function F is calibrated using at least one white and rough target, the surface roughness of which is greater than the wavelength of the light of the first and second light beams.

The use of the function F, a relative mathematical combination of the envelopes of the signals A and B, requires a calibration phase for calibrating this function F. This calibration may be performed using a specific target that is moved metrologically relative to the signal generation system such that the outer surface of the target remains between the geometric points d1 and d2 of the system for generating the representative signals. This target should advantageously be white and rough. The term “white” is understood to mean here that the outer surface of the target should backscatter more light, at the wavelength of the generation system, than it absorbs. And the amount that is backscattered should also advantageously be at least equal to or above the level of light backscattered by the outer surface of the medium that it is desired to measure, thereby guaranteeing the proportionality of the response regardless of the medium to be observed. It is also necessary for this target to have a rough outer surface in order to backscatter the light, and not just reflect it as an optical mirror would. Finally, the surface roughness of the target should be greater than the wavelength of the light of the first and second light beams. Indeed, if the surface roughnesses are not greater than the wavelength, the surface will behave like a mirror at the wavelength in question, and therefore minimize backscattering. Moreover, the speckle phenomenon, that is to say the phenomenon of electromagnetic and in particular optical speckle, will not be present if the roughness condition is not complied with, and it has to be present in order to be able to optionally characterize speckle noise, that is to say noise generated by the phenomenon of electromagnetic speckle, while still being comparable with that of the targets that it is intended to measure.

Preferably, the step of generating the payload signal comprises the following step:
Filtering, through frequency windowing, each payload signal around the at least one Doppler frequency.

Very preferably, the step of generating the payload signal uses frequency windowing between 0.7 and 1.3 times the Doppler frequency.

It is possible, although not necessary, to filter the time signal around the Doppler frequency that carries the payload information in order to isolate a payload time signal that highlights electromagnetic interference. The uncertainty on the exact Doppler frequency naturally leads to selective filtering being carried out around the determined Doppler frequency. The potential uncertainty on the determination of the Doppler frequency leads to the signal being filtered over a width linked to the Doppler frequency, and the windowing between 0.7 and 1.3 times the determined Doppler frequency makes it possible both to cover the uncertainty on the Doppler frequency while focusing on the only fundamental, which generally carries sufficient information.

Preferably, the step of determining the Doppler frequency is performed through:
A Fourier transform of the payload signal; or
The application of a theoretical formula taking into account the relative speed V along the direction U between the generation system and the outer surface, the angle of incidence θ of the beam emitted on the median plane of the outer surface and the wavelength λ of the light beam, defined as follows

$$f = \frac{2 * V * sin ( θ )}{λ} ;$$

or
Temporal analysis of the time signal in order to detect the period between two slots or the length of the slot.

These three methods make it possible to determine a Doppler frequency of the time signal. The second method consists simply in theoretically evaluating the Doppler frequency, knowing the technical characteristics of the generation system. The first method performs a Fourier transform of the time signal in order to extract the fundamental frequency that emerges from the frequency spectrum. If the number of samples of the time signal is a multiple of 2, a fast Fourier transform may be performed, thereby allowing accelerated processing of the function. In the third method, it is necessary to analyse a temporal sample of the signal in order to detect the fringes and in particular the spacing between consecutive fringes in order to deduce the Doppler frequency therefrom. Of course, it is possible to use several of these methods jointly to converge rapidly on the Doppler frequency of the signal. All of these methods may be performed on board the device where the generation system is installed, minimizing computing or memory resources.

Preferably, the step of determining the envelope of the payload signal is performed on the absolute value of the payload signal.

The applicant has observed that determining the envelope on the payload signal when this corresponds to the absolute value of the payload signal provides an increase in robustness for the method for determining the profile of the outer surface. Indeed, the payload signal oscillates around the zero value, and taking the absolute value eliminates interference related to the phase positions of the two payload signals, thereby improving the prediction of the distance d from the outer surface of the medium.

Very preferably, the step of determining the envelope of each payload signal comprises a step of cleaning speckle noise on the determined envelope.

Indeed, it is often preferable to eliminate speckle effects from the determined envelope, that is to say the effects produced by speckle noise, generated by the Doppler effect and the parasitic signals from the backscattering of light. For this purpose, specific filters should be used, such as Lee Sigma or gamma Map filters, which are highly effective for cleaning the selected signature. This cleaning improves the prediction of the profile of the outer surface of the medium by minimizing noise on the payload signal. Cleaning on the envelope makes it possible to statically attenuate measurement noise while determining the parameters of this cleaning a priori, thereby allowing real-time and on-board use of the profile of the outer surface.

Preferably, the step of cleaning speckle noise on the envelope of the signal comprises the following steps:
Determining a time window size and a level of overlap between contiguous windows associated with a filtering method on the system for generating time signals A and B;
Dividing the determined envelope by an integer number N of windows
Determining a characteristic quantity at each window as being an average of the weighted values of the envelope that are contained in said window; and
Defining the cleaned envelope of each signal as being the succession of characteristic quantities of each window.

In order to allow real-time use of the method for obtaining the profile of the outer surface, simple operations should be performed on the time signals resulting from the measurement. After having defined the filtering method used, which depends both on the nature of the outer surface of the medium to be measured and on the measurement system used, the envelope is divided into a multitude of windows the size of which is adapted to the speckle noise, with or without the windows overlapping with one another depending on the filtering method used. For each window that corresponds to the use of a limited memory space, an average of the values of the envelope of the window is computed. These values are potentially weighted in the event of overlap between contiguous windows. The signal reconstituted by the characteristic quantities of each window forms the envelope cleaned of speckle noise.

Very preferably, the filtering method for the step of cleaning the speckle noise is contained within the group comprising GammaMAP and Sigma.

These are filtering methods for which the effectiveness in terms of characterizing roughnesses of a millimetric outer surface is sufficient by using the signal generation systems disclosed in the invention.

Advantageously, the temporal size of the filtering windows and the level of overlap between contiguous windows are determined during a step of calibrating the speckle noise, comprising the following steps:
Using a white and rough target the surface roughness of which is greater than the wavelength of the first and second light beams.
For at least one known position of the target relative to the representative signal generation system;
   Determining the envelope of at least one of the signals A and B;
   Transforming the envelope into the frequency domain in order to obtain a distribution;
Averaging the at least one distribution in order to define a Gaussian speckle distribution related to the generation system;
Defining at least one speckle frequency noise as the product of the Gaussian speckle distribution and a random noise uniformly distributed between 0 and 1;
Applying the at least one speckle noise to a theoretical profile in order to obtain at least one noisy theoretical profile; and
Determining the size of the time window and the level of overlap by minimizing the difference between the theoretical profile and the at least one noisy theoretical profile through statistical analysis.

Indeed, the amplitude of the envelope is at the same time the combination of the reflectivity of the outer surface of the medium at the point of impact of the light beams, of the distance between the point of impact on the outer surface and the focal point of the light beam and speckle noise. This speckle noise is related both to the angles of incidence of the light beams and the distance between the outer surface and the two geometric points d1 and d2. As a result, the speckle noise is related directly to the layout of the signal generation system. The mathematical model of the speckle noise may be the product of a Gaussian frequency distribution and a noise uniformly distributed between 0 and 1. This uniformly distributed noise is statically random, and it is therefore just necessary to identify the correct Gaussian distribution of the frequencies of the speckle noise by calibrating the generation system. Since the Gaussian distribution is of a certain frequency width, it is necessary to take a sufficient time window so as not to amputate the cleaning operation with an error linked to the time/frequency transformation of the signals. This is tantamount to averaging the time signal of the determined envelope over a time long enough to be statically representative of the speckle noise related to the generation system. The first phase is that of quantifying the speckle noise on the responses of the signals from the generation system. For this purpose, a single light path may be analysed on a single position of the target. However, it is preferable to increase the number of positions of the target and to analyse the various signals from the generation system. After having obtained a multitude of envelopes, a Gaussian distribution of these envelopes is determined through a technique of averaging the various distributions obtained. The second step consists in creating a multitude of noisy profiles from a theoretical profile by generating a multitude of speckle noise associated with the generation system. Finally, the optimum time windowing size and the level of overlap between the contiguous windows are determined using statistical analysis on all the noisy profiles in comparison with a known theoretical profile by choosing the parameters that minimize the differences on the entire population of noisy profiles.

Advantageously, the step of combining the cleaned envelopes comprises the difference between the cleaned envelopes expressed on a logarithmic scale.

The applicant has observed that this formatting of the mathematical combination of the cleaned envelopes made it possible to improve the sensitivity of the function F, thereby improving the precision on the evaluation of the distance d from the outer surface of the medium. Due to the Gaussian propagation of the light beams and therefore the backscattered power, the logarithmic scale makes it possible to linearize the backscattered light power as a function of the distance from the focal point of the light beam. The function F is linear in a manner more independent of the position of the geometric points and of the focusing of the light beams at the geometric points.

### BRIEF DESCRIPTION OF THE DRAWINGS

The invention will be better understood on reading the following description in the case of an application involving a fixed device and moving medium under observation. This application is given solely by way of example and with reference to the appended figures, in which:

FIG. 1 is a first example of a first embodiment of a generation system according to the invention.

FIG. 1a is a second example of the first embodiment according to the invention.

FIG. 2 is an example of the second embodiment according to the invention.

FIG. 3 is an overview of the method for evaluating the profile of the outer surface of a medium using signals coming from the generation system of the invention.

FIGS. 4a to 4f illustrate the various steps and the quality of the method for evaluating the profile of an outer surface dynamically and in real time.

### DETAILED DESCRIPTION OF EMBODIMENTS

To implement the invention, it is first necessary to define an optical system that makes it possible to generate two light beams the focal point of which is located on either side of the outer surface that it is desired to observe.

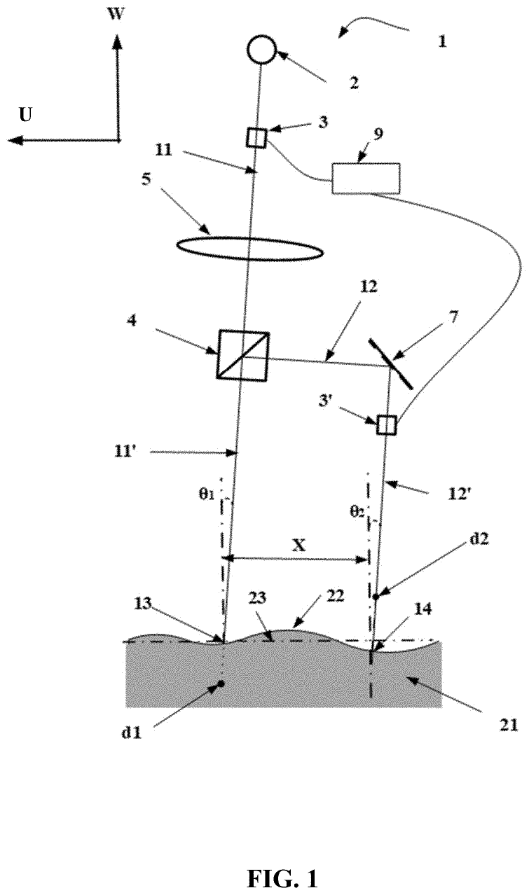

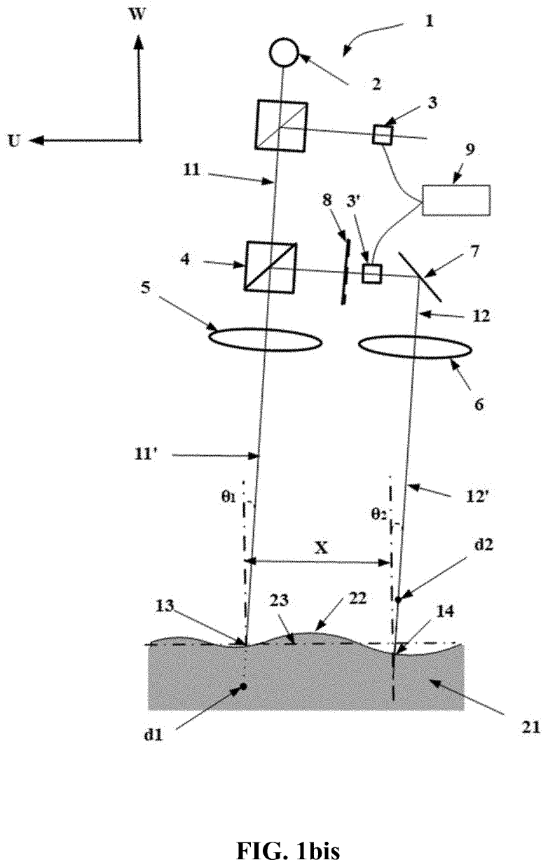

FIG. 1 illustrates an example of a generation system 1 according to the first embodiment, that is to say comprising just a single light source 2 in the case of use of the system with a medium to be studied having an outer surface with a median plane. The first light beam from the first light source 2 is focused using a focusing lens 5 situated upstream of the first optical device 4. This optical device 4 also acts as a means for generating a second light beam that is Gaussian, coherent, monochromatic and, even more, focused. Thus, the second optical path 12 generated at the output of the optical device 4 corresponds to the second optical path 12′. This second light beam is due to the splitting of the light power of the first Gaussian beam through the splitter cube 4. The latter delivers a first optical path 11′ which directs a first part of the first light beam to the outer surface 22 of the medium 21 with an incidence such that the projection θ1 of the angle of incidence with respect to the normal on the median plane 23 of the outer surface 22 is greater than one degree. Thus, with this incidence, the backscattered beam is subjected to the Doppler effect provoked by the speed of movement V between the device comprising the generation system 1 and the medium 21 in the direction U.

Similarly, the second light beam which is the other portion of the first light beam follows a second optical path 12′ towards the outer surface 22 of the medium 21. Here, the means for routing this second light beam comprises a mirror 7 which redirects the second light beam to the outer surface 22. On the second optical path 12′ there is a second light sensor 3′ capable of measuring the electromagnetic interference between the second light beam emitted and the beam backscattered by the outer surface from this second light beam. In this figure, the second sensor 3′ is situated downstream of the mirror 7 along the second optical path 12′ in the incident direction. In our particular case, the projection of the angle of incidence of the second light beam with respect to the normal to the outer surface 22, denoted θ2, is close to or identical to θ1. Since the first and second light beams have the same wavelength 1, the incidences with respect to the normal to the median plane 23 of the outer surface 22 that are similar or identical, the second light sensor is essential for dissociating the two distance information items associated with the first 11′ and second 12′ optical paths.

In order for the backscattered beam from the second optical path 12′ not to disturb the electromagnetic interference between the first light beam and its backscattered beam at the first light sensor 3, it is necessary to apply an absorbent medium to the return path of the second optical path 12′. In this example, the latter is materialized by an unbroken line on the face of the mirror 7. This component absorbs the light backscattered by the outer surface 22. In another alternative, this component could be situated upstream to the splitting face of the splitter cube 4. The objective is for it not to disturb the first incident and backscattered light beams along the first optical path 11.

Obviously, the longer optical path, here the second optical path 12′, comprises a geometric point d2 situated above the outer surface 22 where the second light beam is the more focused. This point corresponds also to the maximum of light backscattered along the second optical path 12. By analogy, the first optical path 11′ is the shorter to reach the outer surface 22. Consequently, its geometric point d1 is situated on the other side of the median plane 23 and virtually inside the medium 21.

Here, the two points of impact 13 and 14 of the first 11′ and second 12′ optical paths are spaced apart by a distance X in the direction U. A time correction between the two signals from the first 3 and second 3′ light sensors will be needed to deduce therefrom the distance d from the outer surface 22 of the medium 21 and thus construct the profile of the outer surface 22. However, with the two optical paths having a similar incidence with respect to the normal to the median plane 23 in a plane defined by the direction U and the normal to the median plane 23, the correction matrix to be used on one or other of the electrical signals is easier to implement which allows a more rapid real time processing. As in FIG. 1, the sensors are, here, both linked to the electronic device comprising a signal amplifier 9 which allows a synchronization of the two measurement channels each from a light sensor 3 and 3′. It is preferably possible to use an electronic device associated with each sensor.

FIG. 1a shows another example of a generation system 1 according to the first embodiment in the case of using the system with a medium to be studied having an outer surface having a median plane. This time, the first light beam from the first light source 2 is focused using a focusing lens 5 located downstream of the first optical device 4. Once again, this optical device 4 also acts as a means for generating a second beam of Gaussian, coherent and monochromatic light. This second light beam is due to the splitting of the light power of the first Gaussian beam through the splitter cube 4. This directs a first portion of the first light beam towards the outer surface 22 of the medium 21 at an incidence such that the projection θ1 of the angle of incidence with respect to the normal along the median plane 23 of the outer surface 22 is greater than one degree. Thus, at this incidence, the backscattered beam is subject to the Doppler effect caused by the speed of movement V between the device comprising the generation system 1 and the medium 21 in the direction U.

Similarly, the second light beam, which is the other portion of the first light beam, follows a second optical path 12′ after having been focused using a second focusing lens 6 towards the outer surface 22 of the medium 21. Here, the means for routing this second light beam comprises a mirror 7 that redirects the second light beam towards the outer surface 22. On the second optical path there is a second light sensor 3′ capable of measuring the electromagnetic interference between the second light beam emitted and the beam backscattered by the outer surface 22 from this second light beam. In this figure, the second sensor 3′ is situated upstream of the mirror 7 along the second optical path 12 in the incident direction. In our particular case, the projection of the angle of incidence of the second light beam with respect to the normal to the outer surface 22, denoted θ2, is close or identical to θ1. Since the first and second light beams have the same wavelength 1, incidences with respect to the normal to the median plane 23 of the outer surface 22 that are similar or identical, the second light sensor 3′ is essential for dissociating the two distance information items associated with the first 11′ and second 12′ optical paths.

Optionally, in order for the backscattered beam from the second optical path 12′ not to disturb the electromagnetic interference between the first light beam and its beam backscattered at the first light sensor 3, it is necessary to apply a light-absorbing medium to the return path of the second optical path 12. In this example, the latter is materialized in the form of a broken line on a transition optical element 8. This component absorbs the light backscattered by the outer surface 22. In another alternative, this component could be situated upstream to the splitting face of the splitter cube 4. The objective is for it not to disturb the first incident and backscattered light beams along the first optical path 11.

It should be noted here that the first light beam has, on its path, a splitter cube which redirects an infinitesimal part of the first light beam, both incident and backscattered, to the first light sensor 3 which is therefore outside of the first optical path 11 towards the outer surface 22. Indeed, it is not necessary for the observation of the electromagnetic interference between the incident beam and the backscattered beam to be done on the optical path. The only condition is that the spatial zone of observation of this electromagnetic interference be a zone of mutual spatial coherence of the beams. Indeed, an initially coherent light beam inevitably loses its coherent nature after a certain spatial and temporal travel.

Obviously, the longer optical path, here the first optical path 11, comprises a focusing point d1 situated under the outer surface 22 where the first light beam is the more focused. This point corresponds also to the maximum of backscattered light along the first optical path 11 despite the fact that this point d1 is virtual, that is to say inside the medium 21. By analogy, the second optical path 12 is the shorter to reach the outer surface 22. Consequently, its geometric point d2 is situated on the other side of the median plane 23. The length of the optical path is here driven by the focusing distance f of the focusing lens and the routing of the optical path from the focusing lens and the outer surface 22. As in FIG. 1a, the focusing lenses 5 and 6 are at the same distance from the outer surface 22 along the routing of the light of each path, and it is the differentiation of the focusing distance of the focusing lens which generates the different lengths along the optical paths 11′ and 12′.

Here, the two points of impact 13 and 14 of the first 11′ and second 12′ optical paths are spaced apart by a distance X in the direction U. A time correction between the two signals from the first 3 and second 3′ light sensors will be needed to deduce therefrom the distance d from the outer surface 22 of the medium 21. However, with the two optical paths having a similar incidence with respect to the normal to the median plane 23 in a plane defined by the direction U and the normal to the median plane 23, the correction matrix to be used on one or other of the electrical signals is easier to implement which allows more rapid real time processing. As in FIG. 1, the sensors are, here, both linked to the electronic device comprising a signal amplifier 9 and which allows a synchronization of the two measurement channels, each from a light sensor 3 and 3′.

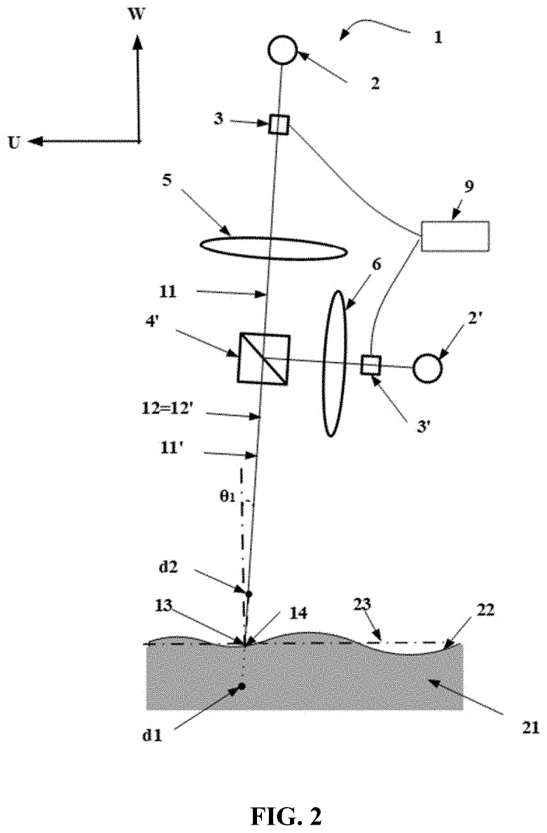

FIG. 2 represents a first example of a generation system 1 according to the second embodiment, that is to say comprising two light sources 2 and 2′ in the case of use of the system with a medium to be studied having an outer surface having a median plane. This time, the first light beam from the first light source 2 is focused using a focusing lens 5 situated upstream of a first optical device 4′ along the incident routing of the light. However, the second light beam is, for its part, generated by a second light source 2′ delivering also a Gaussian, coherent and monochromatic light beam. This second light beam is focused using a second focusing lens 6 situated upstream of the first optical device 4′.

This time, this optical device 4′ redirects the first focused light beam towards the outer surface 22 of the medium 21 along a first optical path 11′. This optical device 4′ also acts as a means for routing the second focused light beam by redirecting the latter towards the outer surface 22 of the medium 21 over a second optical path 12′. However, this optical device 4′ allows the two light beams to be merged into just one, which guarantees that the two optical paths 11′ and 12′ are identical and aligned after the passage of the incident beams through the optical device 4′, which is an optical cube merging the initially non-parallel beams. Thus, the first and second light beams converge towards the outer surface 22 of the medium 21 with the same incidence such that the projection θ of the angle of incidence with respect to the normal on the median plane 23 of the outer surface 22 is greater than one degree. Thus, with this incidence, the backscattered beam is subjected to the Doppler effect provoked by the speed of movement V between the device comprising the generation system 1 and the medium 21 in the direction U. However, since the geometric points d1 and d2 for each of the light beams are wanted to be situated either side of the median plane, it is sufficient for that to relatively displace the two focusing lenses 5 and 6 on their respective optical paths 11′ and 12′ for the focal distance f1 and f2 of each of the lenses to define different geometric points d1 and d2. It is also possible to use focusing lenses 5 and 6 with different focusing distances f1 and f2 so as to define the different geometric points.

Here, the generation system 1 comprises two light sensors 3 and 3′ respectively associated with the first and second optical paths. Each light sensor 3 and 3′ records the electromagnetic interference between the incident light beam and its beam backscattered by the outer surface 22 of the medium 21.

Since the light sources 2 and 2′ are physically dissociated, the light beams from one cannot be coherent with the light beams from the other which limits the interference between the first and second light beams. Thus, the electromagnetic interference measured is linked to a single light source regardless of the wavelength of the light source 2 and 2′.

The two electrical signals from each light sensor 3 and 3′ are synchronized in the electronic device comprising a signal amplifier. The signals do not require any time correction since they have the same point of impact 13 and 14 on the outer surface 22.

Here, this second embodiment is economically interesting if the light sources are conventional laser diodes having, in their amplifying cavity, an integrated photodiode which serves as light sensor 3 or 3′. The packaging is then concentrated and inexpensive allowing economical operation of the generation system 1. Indeed, when a single light source is used as in the case of the first embodiment, the use of a laser source other than a diode can be envisaged. It is also possible to use the amplifying cavity of the laser as preferred spatial zone for observation of the electromagnetic interference. The use of a light sensor in the form of a photodiode or phototransistor linked with the amplifying cavity can be envisaged as can the observation of the laser source power supply parameters using an ammeter or a voltmeter if the laser source is not equipped with electronic regulation of its power supply.

Of course, these examples of the two embodiments are specific applications of the invention, which is not intended to be limited to these examples. In particular, any combination of the characteristics of these examples is conceivable and falls within the general scope of the invention.

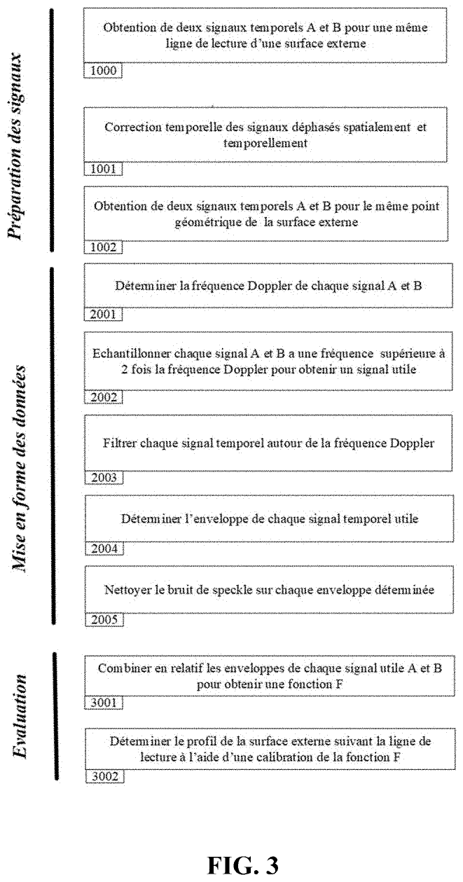

FIG. 3 is an overview of the method for evaluating the distance d of the outer surface from a reference potentially implementing the system for generating at least one signal representative of the profile of an outer surface of an medium moving at a relative speed V with respect to the generation system in a direction U. However, this method is not otherwise intended to be limited to signals output from this generation system.

FIG. 3 comprises three main phases. The first concerns the preparation of electrical signals, for example at the output of the system for generating a signal representative of the profile of the outer surface of the medium. The second phase concerns the implementation of these signals in order to perform the third phase, which is the actual evaluation of the distance d from the outer surface. Of course, this first phase is optional if a measurement system directly generates two signals representative of the profile of the outer surface with respect to known references for the same geometric point of a readout line of the outer surface. This system is for example the first example of the second embodiment of the measurement system of FIG. 2.

The first phase comprises a first step 100 consisting in obtaining two time signals A and B representative of the profile of the outer surface with respect to a readout line. These may for example be the output of the electronic device of the generation system according to the invention. Of course, in this step, it is not certain that the two signals are temporally and spatially phased, which means having to go through the next step 1001. For example, these two points are separated along the readout line of the outer surface by a spacing X, as in the examples of FIGS. 1, 2 and 3.

The second step 1001 corresponds to the spatio-temporal correction to be applied to one and/or the other of the time signals A and B from step 1000. For this purpose, it is necessary to know the method for obtaining the two time signals, that is to say the spatio-temporal spacing between the two measurement points each corresponding to a time signal with respect to a common reference. The spatial position may be a metric position that is obtained visually, for example. The time offset may be the date of crossing in front of a reference point serving for example as a common reference, through a clock signal with a metric for each signal. In addition, it is useful to know the scrolling speed along the readout line of the outer surface associated with each time signal. All of these data make it possible to define a correction matrix to spatio-temporally recalibrate the two signals on one and the same geometric point of the readout line. Applying this correction to the time signals from step 1000 gives the result of step 1002, which ends the signal preparation phase.

The second phase corresponds to formatting of the measured data, which are represented by the time signals obtained in step 1002 from the first phase. The principle of the method according to the invention is that the payload information of the time signals is contained in the fundamental and the harmonics of the Doppler frequency associated with the relative speed V of the medium 21 with respect to the time signal measurement system. This is independent of the physical means for measuring the signals, whether this be light, sound or any other electromagnetic wave.

The first step 2001 consists in defining the Doppler frequency associated with the relative speed V. The Doppler frequency may be determined using a mathematical formula such as, in the case of light signals, the formula linking the relative speed V, the angle of incidence with respect to the normal to the outer surface and the wavelength of the light. It may also result from analysing the signals, whether this analysis be temporal or frequency analysis. Knowing this Doppler frequency, it is necessary for the sampling frequency of the time signals to be at least twice as great as the Doppler frequency, complying with the condition of Shannon's Theorem, in order to ensure that the information of the time signals is plausible and not induced by uncertainty related to the measurement conditions, this corresponding to step 2002. Optionally, it may prove useful to filter the time signals around the Doppler frequency identified in step 2001, and this may be carried out for example over a wide band of between 0.7 and 1.3 times the Doppler frequency. Thus, depending on the mode for identifying the Doppler frequency, theoretically or through frequency analysis of the signals or through temporal analysis of the signals, and also the potential slow evolution of the relative speed V, the Doppler frequency is not necessarily determined in absolute terms, and a wide window then makes it possible to cover all of these uncertainties by isolating the usable information, this corresponding to step 2003. Of course, if the frequency interference related to the signal measurement system is low, it is entirely conceivable to take the complete signal without selective filtering and move directly to step 2004.

Step 2004 consists in focusing on the general signal carrying the information through the envelope of the payload signal. It is expected that this will be an image of the events related to the Doppler frequency associated with the relative speed V. In step 2004, the envelope of the payload time signal is determined, potentially driven by a narrow frequency band around the Doppler frequency. Of course, the envelope of the payload signal may be constructed from the minima, the maxima or the absolute value of the payload signal. The choice of method depends on the nature of the measured signals with respect to the physical quantity under observation.

Optionally, in order to statically eliminate parasitic noise on the envelope of the measured time signal, speckle cleaning is carried out in order to extract the precise information therefrom in step 2005. This makes it possible to statistically eliminate measurement randoms caused by lack of compliance with the conditions for an ideal measurement. This is carried out through a learning campaign on a known target representative of the outer surface of the medium that it is desired to observe using the envisioned measurement system. This learning phase determines a Gaussian distribution of the measurement randoms, which should be coupled with an evenly distributed noise in order to determine a speckle noise. This makes it possible to determine the time windowing of the payload signal that should be taken into account in order to clean the speckle noise by applying the identified Gaussian distribution. Step 2005 consists in removing the determined speckle noise from the envelope signal in order to obtain a cleaned envelope on each measurement channel. This step ends the second data formatting phase.

The last phase is evaluating the variation in the distance d of the outer surface from a reference, making it possible to deduce the profile of the outer surface. This comprises a first step 3001, which consists in mathematically combining the envelopes obtained in steps 2004 or 2005 so as to define a function F that is bijective. The bijectivity of the function F makes it possible to guarantee the uniqueness of the distance d from the outer surface using the information from the two envelopes. In the case of self-mixing, or optical feedback, with Gaussian and coherent light beams, defining the function F as being the difference between the envelopes expressed on a logarithmic scale ensures both monotony and good sensitivity of the function F over the distance range separating the two geometric points d1 and d2 of the generation system presented in the device invention. Precision is enhanced by taking the absolute value of the payload signal to construct the envelopes. Of course, the precision improves when taking the cleaned envelopes.

Finally, to arrive at a relative distance d between various points of the readout line of the outer surface with respect to a reference geometric position, it is necessary to establish a calibration between the result of the function F as defined in step 3001 and a target the position of which is known with respect to the geometric points of the measurement system, this corresponding to step 3002. This makes it possible to convert the response of the function F into a known metric quantity.

To this end, a calibration step should be undertaken using the measuring device, directly or indirectly delivering the time signals with respect to two different geometric points. In the case of the generation system of the device invention, the two geometric points are the points d1 and d2 where each of the light beams are focused and located on either side of the median plane of the outer surface of the medium. Here, the calibration is performed using a target the physical response of which is at least as strong as the outer surface of the medium that it is desired to observe. In the case of the generation system of the device invention, it is necessary to use a white target, that is to say having very high reflectivity with respect to the observation medium. The majority of the incident light is thus backscattered by the surface, which absorbs a very small proportion thereof. In addition, in order to observe light scattering, the target should be rough. However, in order not to be penalized by a large degree of interaction between the light from the generation system and the target, the surface roughness of the target should be greater than that of the medium under observation. It is then sufficient to calibrate the generation system by moving the target between the geometric points d1 and d2 in a known manner and to identify the value of the corresponding function F using the envelopes. This calibration will be used in step 3002 to obtain the distance d from the outer surface of the system. Here, the function F is insensitive to the backscattered power, since the function F is a relative combination of the signal envelopes, such as the linear scale ratio or the logarithmic scale difference. If the combination of the envelopes is absolute, it will be necessary to perform a more precise calibration using a target the physical properties of which are similar to those of the medium that it is desired to observe using the measuring device according to the metric used: light, sound or electromagnetic waves.

The optional speckle noise correction is also performed using the same target as in the signal calibration step. This time, the number of time measurements is increased by moving the target, knowing the result to be achieved in order to evaluate the distribution of the measurements around the reference value. For this purpose, the distribution of the measurements is evaluated in the frequency domain under diversified measurement conditions on a large time sample. This frequency distribution is modelled by a centred Gaussian. The width of this Gaussian determines the minimum size of the measurement time window, so that the Gaussian distribution is statistically representative. The speckle noise is then evaluated through the product of the Gaussian frequency distribution and a noise uniformly distributed between 0 and 1. This speckle noise is to be subtracted from the determined envelope in order to obtain a measurement that depends in the first order only on the reflectivity of the target or the outer surface of the medium under observation. Proportionality is assumed between the reflectivity of the target and that of the outer surface of the medium to be observed, which will be transparent due to the relative combination of the envelopes.

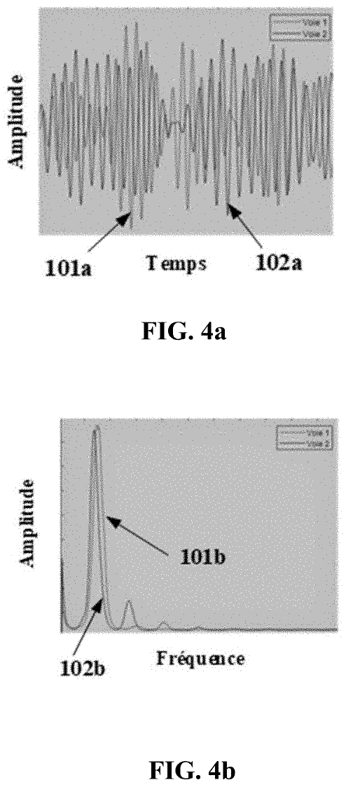

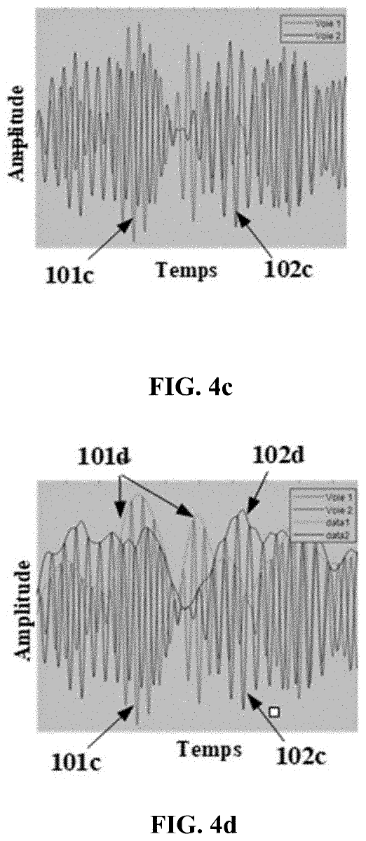

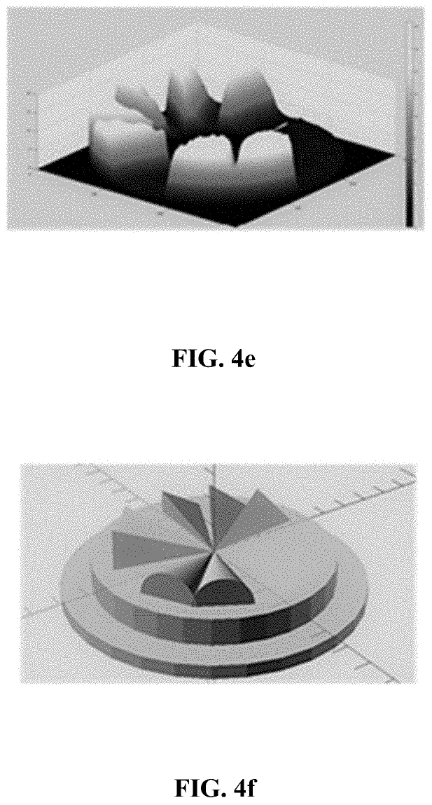

FIGS. 4a to 4e illustrate the method for measuring the profile of an outer surface of a test specimen, for which FIG. 4f shows the three-dimensional reconstruction obtained by photographic means using specific lighting. This circular test specimen has a profile, in the direction of its axis, that evolves non-monotonically as a function of the azimuth. And a proportional evolution of this profile is defined according to the radius from the centre of the circular test specimen. This is mounted on a rotary shaft rotating at an angular speed of the order of 1550 rpm. Finally, the rotary shaft is moved in a translational movement along a direction X, allowing the centre of the circular test specimen to move in translation. The surface roughness of the test specimen is of the order of millimetres with regard to the masses covering 75 percent of the test specimen. The last quarter of the test specimen resembles a smooth surface with a surface roughness of the order of around ten micrometres.

To apply the method, use was made of a preferred generation system according to the second embodiment, the principle of which is illustrated in FIG. 2. It is a generation system comprising two distinct light sources, of which the light power is merged into a single optical path destined for the outer surface of the test specimen. The angle of incidence of the first and second light beams on the outer surface of the test specimen is identical while being contained within a cone with an aperture angle of less than 30 degrees, such that the projection of these angles of incidence with respect to the normal to the median plane of the outer surface in a plane defined by this normal and the direction U of movement of the test specimen is around 5 degrees. In addition, it is ensured that the two light beams have the same point of impact on the outer surface, thereby limiting the corrections to be made to the interferometric signals on the two optical paths. In fact, the readout line on the outer surface of the test specimen is a succession of circles centred on the centre of the circular disk of the test specimen, each circle corresponding to a different translational position of the rotary shaft on which the test specimen is mounted.

The generation system comprises, as light source, a laser diode equipped with a photodiode at the entrance of the amplifying cavity of the laser diode. The laser diode emits a beam of coherent, monochromatic light at the single wavelength and the propagation of which along the direction of the beam is Gaussian. Here, the wavelength of the first laser diode is centred on 1350 nanometres. The second, meanwhile, is centred on 1500 nanometres. The photodiode associated with each laser diode records the electromagnetic interference between the incident light beam and the light beam backscattered by the outer surface of the test specimen. The electromagnetic interference of the first optical path is mainly carried by the harmonics of the first Doppler frequency related directly to the first wavelength, which is inversely proportional to the wavelength. On the other hand, the electromagnetic interference of the second optical path is carried by the harmonics of the second Doppler frequency, the Doppler frequency of which is lower than the first Doppler frequency. The differentiation of the geometric points d1 and d2 where the first and second optical paths are collimated is defined by the length of the optical paths. Here, the first optical path towards the outer surface is defined by the first focusing lens through its position on the first optical path and its focal length. The second optical path comprises a mirror, integrated into the merging optical element in order to redirect the second light beam towards the outer surface of the test specimen. The geometric point d2 is controlled directly by the positioning and the focal length of the second focusing lens of the generation system. Thus, at the output of the electronic device, two electrical signals, each associated with a photodiode are obtained, containing the payload information carried by the harmonics of each different Doppler frequency. It should be noted that, if identical laser diodes are used on the first and second light sources, the same output signals of the generation system would still be obtained because of the coherence of the light beam from each diode which limits the interference between the light beams.

The measurement is carried out by fixing the generation system on a static device located in line with the test specimen such that the geometric points d1 and d2 are located on either side of the outer surface of the test specimen. In our case, they are equidistant from the median plane of the outer surface of the test specimen, at a distance of around 5 millimetres. The spacing between the geometric points is thus of the order of a centimetre, which is less than the variations in the profile of the outer surface of the test specimen, while being greater than the Rayleigh length of the first and second Gaussian light beams.

FIG. 4a shows the temporal evolution in terms of amplitude of two signals. The first signal 101a comes from the photodiode associated with the first light source, and the second signal 102a comes from the photodiode associated with the second light source. Here, the observed interference expresses amplitude modulations of the time signal around a carrier. The succession of fronts is related directly to the interference, which evolves with the position of the points of impact of the light beams on the outer surface of the surface.

FIG. 4b is the frequency spectrum of the time signals from FIG. 4a for each of the signals. The first response spectrum 101b is mainly characterized by a mass centred on the first Doppler frequency. The second curve 102b is characterized by a succession of harmonics associated with the second Doppler frequency. The two Doppler frequencies are slightly offset in terms of frequency. Regardless of the spectral response of the signals, the fundamental frequency carries most of the energy of the signal. In addition, it is possible to note an emergence on each signal at very low frequency, which is similar to a structural mode of the device or of the generation system used. Indeed, this emergence appears on both spectra. Therefore, the temporal response is marred by the signature of the static device or of the generation system, and should be eliminated.

FIG. 4c shows time signals 101c and 102c that correspond to the signals 101a and 102a, respectively, by filtering its signals over a narrow frequency band around the fundamental Doppler frequency of each signal. These corrected time signals eliminate the vibrational contribution of the structural mode of the device or of the generation system. The frequency band is between 0.7 and 1.3 times the Doppler frequency, although a wider band could have been suitable, such as for example between 0.5 and 1.5 times the Doppler frequency. The spectral signature of each time signal with harmonics of the Doppler frequency, which are relatively unused, allows such a correction without causing a loss of information on the electromagnetic interference observed by the photodiodes. If the information is also carried by the harmonics, the harmonics should be taken into account by way of the filtering step.

FIG. 4d shows the definition of the envelopes 101d and 102d based on the filtered time signals 101c and 102c. Here, the envelopes 101d and 102d are constructed on the maxima of the time signals 101c and 102c.

Finally, a surface profile illustrated in FIG. 4e is reconstructed by combining the previously obtained envelopes 101d and 102d. Since the time signals are obtained in-phase during acquisition, no spatio-temporal correction step needs to be performed on the time signals. Here, the profile is constructed at each time sample, by taking the difference between the logarithms of the amplitudes of the envelopes 101d and 102d. Due to the spacing between the geometric points and the formation of the waists of the laser; the term “waist” is understood to mean the width of the laser beam at the focal point, at the geometric points, bijectivity of the abovementioned combination makes it possible to associate a single distance D with each combination. The distance D is measured with respect to any real or notional reference point of the measuring device. Here, for the profile, only the relative position of one sample with respect to another is of interest, regardless of the reference point. The distance D is obtained from a calibration phase of calibrating the measuring device using a white circular target the surface roughness of which is greater than the wavelengths of the first and second light beams. The cylindrical surface has a cylindrical outer surface the profile of which evolves with the radius of the cylinder and does not vary with the azimuth of the cylinder. The relative combination of the envelopes obtained using the method corresponding to the bijective function F is then compared with the altitude of the profile of the target.

FIG. 4f is the three-dimensional reconstruction of the test specimen after post-processing of the images obtained by multiple static cameras and depending on specific lighting. This reconstruction should be compared with the image in FIG. 4e. It is possible to note a similarity of the profiles between the measurement obtained using the method and the static reconstruction on the global and local level. Indeed, local imperfections may be observed in the second order, which corresponds to the spacing between two measurement circles of the test specimen. Simply smoothing the points makes it possible to overcome this problem.

1.-14. (canceled)

15. A system (1) for generating at least one signal representative of the profile of an outer surface (22) of a medium (21) having a median plane (23) and having a relative speed V with respect to the system in a direction U, comprising:
a first light source (2) able to emit a first light beam, the first light beam being a Gaussian beam of coherent and monochromatic light, a wavelength λ1 of which is adapted to optical absorption characteristics of the medium (21), along a first optical path (11);
a first sensor (3) able to evaluate effects of electromagnetic interference between a portion of the first light beam and a portion of the first light beam backscattered from the outer surface (22) of the medium (21) of the first light beam, and delivering a first electrical signal;
a means (2′, 4) for generating at least one second light beam, the at least one second light beam being a Gaussian beam of coherent and monochromatic light of wavelength λ2 adapted to the optical absorption characteristics of the medium (21) along a second optical path (12);
a second sensor (3′) located on the second optical path (12) able to evaluate effects of electromagnetic interference between a portion of the second light beam and a portion of the second light beam backscattered from the outer surface (22) of the medium (21), and delivering a second electrical signal;
at least one first focusing lens (5, 6) located on the first and/or the second optical path (11, 12) for focusing all or part of a corresponding light beam at a focusing distance f and defining an upstream optical path (11′, 12′); and
a means (4′, 7) for routing the at least one second light beam able to redirect at least a portion of the second optical path (12′) in the same direction as a portion of the first optical path (11′),
wherein the two optical paths (11′, 12′) are coplanar,
wherein the wavelengths of the first and second light beams have the same sensitivity to the optical reflectivity characteristics of the outer surface (22) of the medium (21),
wherein a combination of the focusing distance (f1, f2) and the optical path (11′, 12′) for each light beam defines two distinct geometric points d1 and d2 corresponding to a focal point of each light beam,
wherein a distance between the geometric points d1 and d2 is greater than a greatest Rayleigh length of the first and second light beams, and
wherein direction vectors of the first and second optical paths (11′, 12′) define an angle θ less than 3 degrees.

16. The system (1) for generating at least one signal representative of the profile of an outer surface (22) of a medium (21) according to claim 15, wherein the means for generating the at least one second light beam is an optical splitter element (4) situated on the first optical path (11) of the first light beam, the at least one second light beam is the other part of the light beam split by the optical element (4), and the second optical path comprises, along the second incident optical path (12), the second sensor (3′).

17. The system (1) for generating at least one signal representative of the profile of an outer surface (22) of a medium (21) according to claim 16, wherein the second optical path comprises an optical element (8) able to absorb the light on a return path upstream of the second sensor (3′).

18. The system (1) for generating at least one signal representative of the profile of an outer surface (22) of a medium (21) according to claim 15, wherein the means for generating the at least one second beam is a second light source (2′), the system (1) further comprises a second focusing lens (6) at the focusing distance f2 and the system further comprises an optical element (4′) able to merge the first and second optical paths (11, 12) such that the first and second optical paths (11, 12) are aligned.

19. The system (1) for generating at least one signal representative of the profile of an outer surface (22) of a medium (21) according to claim 18, wherein the second light source is a laser diode.

20. The system (1) for generating at least one signal representative of the profile of an outer surface (22) of a medium (21) according to claim 15, wherein the system (1) further comprises at least one electronic device (9) at an output of the electrical signal from the first and/or second sensor (3, 3′), comprising an electronic amplifier circuit.

21. The system (1) for generating at least one signal representative of the profile of an outer surface (22) of a medium (21) according to claim 15, wherein the first and second sensors (3, 3′) are selected from the group consisting of a phototransistor, a photodiode, an ammeter and a voltmeter.

22. The system (1) for generating at least one signal representative of the profile of an outer surface (22) of a medium (21) according to claim 15, wherein the wavelength of the first light beam is between 200 and 2000 nanometers.

23. The system (1) for generating at least one signal representative of the profile of an outer surface (22) of a medium (21) according to claim 15, wherein the first light source is a laser diode.

24. A static or mobile device equipped with the system (1) for generating at least one signal representative of the profile of an outer surface (22) of a medium (21) according to claim 15.

25. The system (1) for generating at least one signal representative of the profile of an outer surface (22) of a medium (21) according to claim 15, wherein, in use, with the first optical path (11′) pointing towards the outer surface (22) at a first angle of incidence θ1 with respect to a normal to the median plane (23) of the surface (22) and the second optical path (12′) pointing towards the outer surface (22) at a second angle of incidence θ2 with respect to the normal to the median plane (23) of the surface (22), the angles of incidence θ1 and θ2 are greater than 1 degree with respect to the normal to the median plane (23) of the outer surface (22) of the medium (21) and the geometric points d1 and d2 are located on either side of the median plane (23) of the outer surface (22).

26. The system (1) for generating at least one signal representative of the profile of an outer surface (22) of a medium (21) according to claim 25, wherein the first and second optical paths do not intersect before having reached the outer surface (22).

27. The system (1) for generating at least one signal representative of the profile of an outer surface (22) of a medium (21) according to claim 25, wherein a coherence length of the first light beam and/or of the second light beam is at least greater than twice a greatest length of the first (11) and second (12) incident optical paths to the outer surface (22) of the medium (21).

28. The system (1) for generating at least one signal representative of the profile of an outer surface (22) of a medium (21) according to claim 25, wherein the angles of incidence θ1 of the first light beam and θ2 of the second light beam are contained within a cone, the axis of revolution of which is the normal to the median plane (23) of the outer surface (22), and an aperture angle of the cone is less than or equal to 45 degrees.
